(19) United States
(12) Patent Application Publication
(10) Pub. No.: US 2007/0270591 A1
(43) Pub. Date: Nov. 22, 2007

(54) Iron (II) amino acid chelates with reducing agents attached thereto

(76) Inventor: H. DeWayne Ashmead, Fruit Heights, UT (US)

Correspondence Address: THORPE NORTH & WESTERN, LLP., 8180 SOUTH 700 EAST, SUITE 350, SANDY, UT, 84070, US

(21) Appl. No.: 11/436,112

(22) Filed: May 16, 2006

(51) Int. Cl. C07F 17/02

(52) U.S. Cl. 548/101; 548/402; 556/148

(57) ABSTRACT

The present invention is drawn to compositions and methods that include iron (II) amino acid chelate having a reducing agent bonded thereto. The reducing agent can be configured to substantially maintain the iron (II) in its ferrous oxidation state. The iron (II) amino acid chelate can have an amino acid ligand to iron (II) molar ratio from 1:1 to 2:1 and a reducing agent ligand to iron (II) molar ratio from 1:1 to 4:1, with a proviso that the combination of the amino acid ligands and the reducing agent ligands satisfies from 3 to 6 of the coordination sites of the iron (II).

### FIELD OF THE INVENTION

The present invention is drawn to compositions and methods for administering iron (II) amino acid chelates. More specifically, the present invention is drawn to delivering iron (II) amino acid chelates such that an increased amount of the iron (II) remains in its ferrous oxidation state, thus providing enhanced intestinal absorption.

### BACKGROUND OF THE INVENTION

Chelates, such as iron amino acid chelates, are generally produced by the reaction between ligands and metal ions having a valence of two or more to form a ring structure. In such a reaction, the electrons available from the electron-donating group of the ligand can satisfy the positive electrical charge of the metal ion. Specifically, the term “chelate” has been defined as a combination of a metallic ion bonded to one or more ligands to form a heterocyclic ring structure. Under this definition, chelate formation through neutralization of the positive charge(s) of the metal ion may be through the formation of ionic, covalent, or coordinate covalent bonding. An alternative and more modern definition of the term “chelate” requires that the metal ion be bonded to the ligand solely by coordinate covalent bonds forming a heterocyclic ring. In either case, both are definitions that describe a metal ion and a ligand forming a heterocyclic ring. Chelation can be confirmed and differentiated from mixtures of components by infrared spectra through comparison of the stretching of bonds or shifting of absorption caused by bond formation.

As applied in the field of mineral nutrition, there are certain “chelated” products that are commercially utilized. The first is referred to as a “metal proteinate.” The American Association of Feed Control officials (MFCO) has defined a “metal proteinate” as the product resulting from the chelation of a soluble salt with amino acids and/or partially hydrolyzed protein. Such products are referred to as the specific metal proteinate, e.g., copper proteinate, zinc proteinate, etc. Sometimes, metal proteinates are even referred to as amino acid chelates, though this characterization is not completely accurate.

The second product, referred to as an “amino acid chelate,” when properly formed, is a stable product having one or more five-membered rings formed by a reaction between the amino acid and the metal. The American Association of Feed Control Officials (AAFCO) has also issued a definition for amino acid chelates. It is officially defined as the product resulting from the reaction of a metal ion from a soluble metal salt with amino acids having a mole ratio of one mole of metal to one to three (preferably two) moles of amino acids to form coordinate covalent bonds. The average weight of the hydrolyzed amino acids must be approximately 150 and the resulting molecular weight of the chelate must not exceed 800. The products are identified by the specific metal forming the chelate, e.g., iron amino acid chelate, copper amino acid chelate, etc. A typical ferrous iron amino acid chelate can include one ferrous ion which acts as a closing member for two amino acid rings, thereby forming an ferrous iron amino acid chelate having a 1:2 molar ratio.

In further detail with respect to amino acid chelates, the carboxyl oxygen and the α-amino group of the amino acid each bond with the metal ion. Such a five-membered ring is defined by the metal atom, the carboxyl oxygen, the carbonyl carbon, the α-carbon and the α-amino nitrogen. The actual structure will depend upon the ligand to metal mole ratio and whether the carboxyl oxygen forms a coordinate covalent bond or an ionic bond with the metal ion. Generally, the ligand to metal molar ratio is at least 1:1 and is preferably 2:1 or 3:1. However, in certain instances, the ratio may be 4:1. Most typically, an amino acid chelate with a divalent metal can be represented at a ligand to metal molar ratio of 2:1 according to Formula 1 as follows:

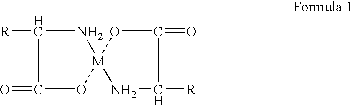

In the above formula, the dashed lines represent coordinate covalent bonds, covalent bonds, or ionic bonds. M represents a metal, such as ferrous iron. Further, when R is H, the amino acid is glycine, which is the simplest of the α-amino acids. However, R could be representative of any other side chain that, when taken in combination with the rest of the ligand structure(s), results in any of the other twenty or so naturally occurring amino acids derived from proteins. All of the amino acids have the same configuration for the positioning of the carboxyl oxygen and the a-amino nitrogen with respect to the metal ion. In other words, the chelate ring is defined by the same atoms in each instance, even though the R side chain group may vary.

With respect to both amino acid chelates and metal proteinates, the reason a metal atom can accept bonds over and above the oxidation state of the metal is due to the nature of chelation. For example, at the α-amino group of an amino acid, the nitrogen contributes both of the electrons used in the bonding. These electrons fill available spaces in the d-orbitals forming a coordinate covalent bond. Thus, a metal ion with a normal valency of +2 can be bonded by four bonds when fully chelated. In this state, the chelate is completely satisfied by the bonding electrons and the charge on the metal atom (as well as on the overall molecule) is zero. As stated previously, it is possible that the metal ion can be bonded to the carboxyl oxygen by either coordinate covalent bonds or ionic bonds. However, the metal ion is preferably bonded to the α-amino group by coordinate covalent bonds only.

The structure, chemistry, bioavailability, and various applications of amino acid chelates are well documented in the literature, e.g. Ashmead et al., Chelated Mineral Nutrition, (1982), Chas. C. Thomas Publishers, Springfield, Ill.; Ashmead et al., Intestinal Absorption of Metal Ions, (1985), Chas. C. Thomas Publishers, Springfield, Ill.; Ashmead et al., Foliar Feeding of Plants with Amino Acid Chelates, (1986), Noyes Publications, Park Ridge, N.J.; U.S. Pat. Nos. 4,020,158; 4,167,564; 4,216,143; 4,216,144; 4,599,152; 4,725,427; 4,774,089; 4,830,716; 4,863,898; 5,292,538; 5,292,729; 5,516,925; 5,596,016; 5,882,685; 6,159,530; 6,166,071; 6,207,204; 6,294,207; 6,614,553; each of which are incorporated herein by reference.

Taking iron amino acid chelates as an example, one advantage of amino acid chelates in the field of mineral nutrition is attributed to the fact that these iron chelates can be readily absorbed from the gut and into mucosal cells by means of active transport. In other words, the iron can be absorbed along with the amino acids as a single unit utilizing the amino acids as carrier molecules. Therefore, the problems associated with the competition of iron for active sites and the suppression of specific nutritive mineral elements by others can be avoided.

Even though chelation improves the bioavailability of many minerals, including iron, through the use of active transport and other absorption mechanisms, traditional amino acid chelates have yet to maximize bioavailability. As such, it would be beneficial to further increase the bioavailability of specific minerals, such as iron.

### SUMMARY OF THE INVENTION

It has been recognized that iron (II) amino acid chelates can be bonded to a reducing agent, thereby providing an improved means of maintaining the iron (II) in its ferrous oxidation state, which in turn, increases the bioavailability of iron in a subject.

Additional features and advantages of the invention will be apparent from the detailed description that illustrates, by way of example, features of the invention.

### DETAILED DESCRIPTION OF THE PREFERRED EMBODIMENT(S)

Before the present invention is disclosed and described, it is to be understood that this invention is not limited to the particular process steps and materials disclosed herein because such process steps and materials may vary somewhat. It is also to be understood that the terminology used herein is used for the purpose of describing particular embodiments only. The terms are not intended to be limiting because the scope of the present invention is intended to be limited only by the appended claims and equivalents thereof.

It is to be noted that, as used in this specification and the appended claims, the singular forms “a,” “an,” and “the” include plural referents unless the context clearly dictates otherwise.

The term “amino acids” or “naturally occurring amino acids” shall mean a-amino acids that are known to be used for forming the basic constituents of proteins, including alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine, valine, and combinations thereof.

The term “amino acid chelate” is intended to cover traditional amino acid ligands, i.e., those used in forming proteins. The amino acid chelate is meant to include metal ions, e.g., ferrous iron ions, bonded to proteinaceous (typically single amino acids) ligands forming heterocyclic rings. Between the carboxyl oxygen and the metal, the bond can be covalent or ionic, but is preferably coordinate covalent. Additionally, at the α-amino group, the bond is typically a coordinate covalent bond. Proteinates of naturally occurring amino acids are also included in this definition.

The term “proteinate” when referring to an iron proteinate is meant to include compounds where iron is chelated or complexed to hydrolyzed or partially hydrolyzed protein forming a heterocyclic ring. Coordinate covalent bonds, covalent bonds, and/or ionic bonding may be present in the chelate or chelate/complex structure. As used herein, proteinates are included when referring to amino acid chelates.

The term “carrier” is meant to include any pharmacological substance or nutritional supplement that is commonly used in the art to carry amino acid chelates, including without limitation, organic acids, free amino acids, amino acid salts, fillers, flow control agents, lubricants, hydroscopicity minimizing agents, pH control agents, catalysts, dust control agents, binders, disintegrating agents, flavoring agents, taste-reducing agents, capsule shells, shellacs, waxes, emulsifiers, oils, combinations thereof, and other known additives.

The term “reducing agent” is meant to mean any compound capable of reducing a metal or maintaining a metal in a given oxidation state, including inorganic and organic acids. As a ligand, a reducing agent can be a unidentate ligand or a bidentate ligand. Typically, a bidentate ligand can be chelated to a metal, e.g., a ferrous iron ion, whereas a unidentate ligand is complexed to the metal at a single location. In accordance with embodiments of the present invention, the reducing agent is bonded to the amino acid chelate, either by coordinate, covalent, or ionic bond(s).

The term “coordination site” is meant to mean the site at which a ligand may bond to the metal, e.g., a ferrous iron ion. The number of coordination sites for any given metal is defined by the amount of empty d-orbitals contained by that metal. Typically, the reducing agent's electrons fill available spaces in the d-orbitals of the metal forming a coordinate covalent bond. However, it is possible that the metal can be bonded to the reducing agent by covalent, coordinate covalent, or ionic bonds.

The term “iron (II) amino acid chelate bonded to a reducing agent” or “iron (II) amino acid chelate with a reducing agent bonded thereto” is meant to mean a compound that includes a minimum of one amino acid chelated to ferrous iron and bonded to at least one reducing agent. As used herein, an iron (II) amino acid chelate bonded to a reducing agent would use a minimum of 3 coordination sites, 2 for the amino acid and 1 for the reducing agent.

With these definitions in mind, it has been recognized that it would be advantageous to administer iron (II) amino acid chelates bonded to a reducing agent. Thus, compositions and methods of delivering iron (II) amino acid chelates bonded to a reducing agent are provided herein. The amino acid selected for use can be a naturally occurring amino acid. The iron (II) amino acid chelate bonded to a reducing agent formed can have a naturally occurring amino acid to iron (II) molar ratio of from 1:1 to 2:1 and a reducing agent to iron (II) molar ration of from 1:1 to 4:1. In one embodiment, for example, the composition can comprise an iron (II) amino acid chelate bonded to a reducing agent dispersed or dissolved in a liquid carrier, wherein the iron (II) amino acid chelate bonded to a reducing agent is present in an amount which provides a therapeutic effect over time. In another embodiment, the composition can comprise an iron (II) amino acid chelate bonded to a reducing agent incorporated in a solid dosage form suitable for oral delivery.

An iron (II) amino acid chelate bonded to a reducing agent can be a valuable component for inclusion in various compositions for several reasons. First, they increase the bioavailability of ferrous iron. Since, the ferrous iron in the iron (II) amino acid chelates readily oxidizes to ferric iron in the presence of oxygen or certain oxygen containing substances such as water or alkaline components, ingestion of unprotected ferrous iron chelate will readily oxidize to ferric iron chelate in the intestinal tract. As ferric iron is absorbed at a much lower rate than ferrous iron even in the chelated form, ferric iron is less bioavailable to mammals than ferrous iron. Therefore, in order to maximize the bioavailbility of iron, the present invention not only chelates ferrous iron to amino acids to help facilitate active transport into mucosal cells, but also keeps iron in its ferrous state by bonding iron (II) amino acid chelates with a reducing agent. Ferrous bisglycinate Is absorbed 2.3 times better than ferric trisglycinate. Both are better than ferrous sulfate. Additionally, the reducing agents in iron (II) amino acid chelates can have nutritional value. Reducing agents that protect ferrous iron from oxidation include nutritionally beneficial compounds such as ascorbic acid (Vitamin C) and citric acid. Further, iron (II) amino acid chelates provide a supplemental source of amino acids as well, which can be beneficial in maintaining good health.

### Preparation of Iron (II) Amino Acid Chelates With a Reducing Agent

The present invention contemplates several methods of preparing iron (II) amino acid chelates bonded to a reducing agent. In one embodiment, the iron (II) amino acid chelate is prepared prior to the bonding of the reducing agent. In another embodiment, the formation of the iron (II) amino acid chelate occurs subsequent to the bonding of the reducing agent. In yet another embodiment, the iron (II) amino acid chelate is formed at substantially the same time as the bonding of the reducing agent.

Various methods for the preparation of amino acid chelates can be used in accordance with embodiments of the present invention. In one embodiment, the formation of an amino acid chelate can be carried out by adding either a metal sulfate or a combination of either a metal oxide or metal carbonate and a weak acid. Additionally, elemental iron can also be used to form such chelates. Formulas 2-5 contain exemplary embodiments of the two-step process where the iron (II) amino acid preparation is preformed prior to the bonding of the reducing agent. Specifically, Formulas 24 show examples of the iron (II) amino acid chelate preparation and Formula 5 shows an example of the subsequent bonding of the reducing agent.

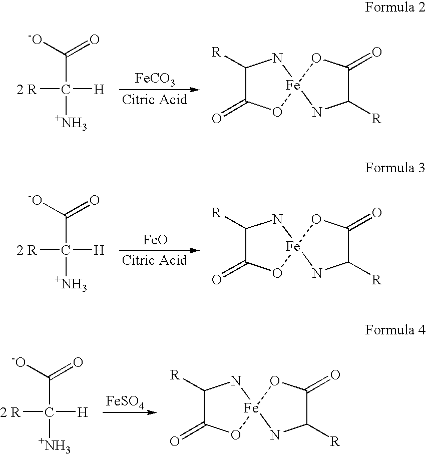

### In one embodiment, once the iron (II) amino acid chelate is prepared, the chelate can be subsequently bonded to the reducing agent as shown in Formula 5 below.

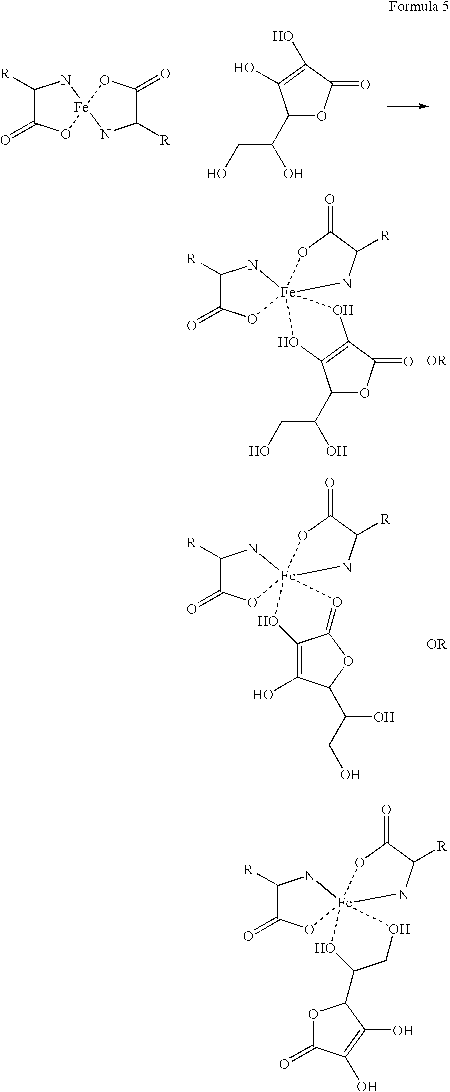

In the above formulas, the dashed lines represent coordinate covalent bonds, covalent bonds, or ionic bonds. Additionally, Formula 5 shows several possible products where different functional groups of the reducing agent bonded to the iron (II) amino acid chelate as a ligand; however, the reducing agent may bond to the chelate in other ways, and as such, the bonding mechanisms shown should not be viewed as restrictive.

Though the above reaction schemes are shown, there are other methods of preparing iron (II) amino acid chelates having a reducing agent bonded thereto that can be used in accordance with embodiments of the present invention. For example, the amount of organic acid used to react with the iron (II) amino acid chelate can be added at a sufficient molar ratio to provide resultant compositions having additional reducing agent moieties attached thereto, e.g., two reducing agent ligands rather than one attached to the chelate. Thus, the above example illustrates only one embodiment of the present invention where the iron (II) amino acid chelate formation and bonding of the reducing agent occur in sequence, and where the amino acid to iron (II) ratio is 2:1 and the reducing agent to iron (II) ratio is 1:1. However, a 1:1 amino acid to iron (II) molar ratio can also be used to form iron (II) amino acid chelates in accordance with embodiments of the present invention. Likewise, a reducing agent to iron (II) molar ratio can be from 2:1 to 4:1, depending upon the available coordination sites of iron (II) in accordance with embodiments of the present invention. Additionally, in Formulas 2-5 above, R can be a pendent group that completes one of the 20 or so naturally occurring amino acids, as is known in the art. For example, if R is H, then the amino acid is glycine.

Specific examples of preferred iron (II) amino acid chelates that can be prepared include embodiments wherein the amino acid to iron (II) molar ratio is about 2:1 and the reducing agent to iron (II) molar ratio is about 1:1. For example, in certain embodiments, ferrous iron can be chelated with a naturally occurring amino acid such as glycine and a reducing agent such as ascorbic acid to provide ferrous bisgylcinate ascorbate. In yet another embodiment, the amino acid to iron (II) molar ratio can be about 1:1 and the reducing agent to iron (II) molar ratio can be about 2:1. This being stated, though glycine is preferred for use in some embodiments, there are many applications where the use of amino acids other than glycine might be preferred. For example, alanine, leucine, phenylalanine, lysine, cystine, and methionine might be preferred in certain embodiments. Further, any other of a number of combinations of iron (II) with amino acids and reducing agents is also contemplated for use in accordance with embodiments of the present invention.

### Additives

Depending on the amount of iron (II) to be administered in an iron (II) amino acid chelate-containing composition, additives can be included with the compositions to provide desired properties that may not be inherently present in the iron (II) amino acid chelates per se. Examples of formulation additives that can be admixed or co-administered with the iron (II) amino acid chelates of the present invention include organic acids, free amino acids, amino acid salts, fillers, flow control agents, lubricants, hydroscopicity minimizing agents, pH control agents, catalysts, dust control agents, binders, disintegrating agents, flavoring agents, taste-reducing agents, capsule shells, shellacs, waxes, emulsifiers, oils, combinations thereof, and other known additives.

More specifically, there are certain additives which can be included in amino acid chelate-containing compositions that provide desired properties to the composition during formulation or to the finished composition. For example, maltodextrin can be added as a filler and a flow agent when making a particulate amino acid chelate composition. Additionally, maltodextrin can help to reduce the hydroscopicity of the composition as a whole. Grain flours, such as rice flour or wheat flour, can also be added as a filler, as well as vegetable flours or powders, such as soy flour. In another embodiment, a filler that can be added is inulin, such as low fiber inulin derived from chicary. Fumed silica, stearic acids, and/or talc can also be added as a flow controlling agents. In addition to the flow agents and fillers, other compositions that can be added include organic acids. Citric acid, fumaric acid, succinic acid, tartaric acid, malic acid, lactic acid, gluconic acid, ascorbic acid, pantothenic acid, folic acid, lipoic acid, oxalic acid, maleic acid, formic acid, acetic acid, pyruvic acid, adipic acid, and alpha-ketoglutaric acid are each exemplary of such organic acids, though others can also be used. Free amino acids or amino acid salts can also be present in the composition. Additionally, mineral oils for dust control, binders for tableting (carboxymethyl cellulose, ethyl cellulose, glycerol, etc.), flavoring agents or taste-free additives for organoleptic properties, or the like can also be included. These additives can be included to the extent that they are appropriate for the dosage form the amino acid chelate is to be incorporated within.

Other classes of formulation additives that can be included with the iron (II) amino acid chelates are drugs, vitamins, enzymes, cofactors, herbs or herbal extracts, protein powders, or the like. Vitamins that can be used include Vitamin A, the Vitamin B group of vitamins, e.g., folic acid, Vitamin B₁, Vitamin B₂, Vitamin B₃, Vitamin B₅, Vitamin B₆, or Vitamin B₁₂, Vitamin C, Vitamin D, Vitamin E, and the like. Coenzymes can also be used, which are organic compounds that combine with apoenzymes to form active enzymes. Cofactors that can be present include coenzymes and metals that are required for an enzyme to be active, some of which can be provided by the metal amino acid chelate itself. Herbs can also be coadministered with the chelates in accordance with embodiments of the present invention. Further, drugs can be coadministered with amino acid chelates in a dosage form include any drug that would benefit from the inclusion of an appropriate amino acid chelate. For example, if a subject is taking a drug for a blood disorder, it may be beneficial to coadminister that drug with an iron amino acid chelate in some circumstances.

### EXAMPLES

The following examples illustrate the embodiments of the invention that are presently best known. However, it is to be understood that the following are only exemplary or illustrative of the application of the principles of the present invention. Numerous modifications and alternative compositions, methods, and systems may be devised by those skilled in the art without departing from the spirit and scope of the present invention. The appended claims are intended to cover such modifications and arrangements. Thus, while the present invention has been described above with particularity, the following examples provide further detail in connection with what are presently deemed to be the most practical and preferred embodiments of the invention.

### Example 1

One mole of a soluble ferrous salt is reacted with two moles of sodium glycinate and one mole of ascorbic acid in an aqueous solution to produce ferrous bisglycinate ascorbic acid chelate. Specifically, two moles of sodium glycinate (194.1 g) and one mole of ascorbic acid (176.1 g) were dissolved in one liter of water, and the mixture was brought to 55-60° C. Next, 1.0 mole (126.8 g) of ferrous chloride was added to the mixture, and the mixture was allowed to react for a total of 4 hours. After the 4 hour reaction time, the composition was cooled 40° C. and spray dried to obtain about 380.1 g of ferrous bisglycinate ascorbate at 100% yield.

### Example 2

One mole of ferrous oxide is reacted with two moles of sodium glycinate in the presence of citric acid in an aqueous solution to form ferrous bisglycinate. The ferrous bisglycinate is further reacted in a 1:1 molar ratio with citric acid to form ferrous bisglycinate citric acid chelate. Specifically, two moles of sodium glycinate (194.1 g) were dissolved in one liter of 0.5 M citric acid, and the mixture was brought to 55-60° C. Next, 1.0 mole (71.8 g) of ferrous oxide was added to the mixture, and the mixture was allowed to react for 1 hour forming ferrous bisglycinate. Next, one mole of citric acid (192.1 g) was added to the reaction mixture. After a 4 hour reaction time, the composition was cooled 40° C. and spray dried to obtain about 394.0 g of ferrous bisglycinate citrate at 100% yield.

### Example 3

One mole of iron acetate is reacted with two moles of glycine in an aqueous solution to produce ferrous bisglycinate acetic acid chelate. Specifically, one mole of ferrous acetate (173.9 g) and two moles of sodium glycinate (194.1 g) were dissolved in one liter of water, and the mixture was brought to 55-60° C. After a 4 hour reaction time, the composition was cooled 40° C. and spray dried to obtain about 368.0 g of ferrous bisglycinate acetate at 100% yield.

### Example 4

One mole of elemental iron is reacted with two mole of hydrochloric acid in an aqueous solution to form one mole of ferrous (II) chloride. The one mole of ferrous chloride is further reacted with two moles of glycine in one liter of a 1 M aqueous hydrochloric acid solution to form ferrous bisglycinate HCl. Specifically, one mole of elemental iron (55.8 g) was dissolved in one liter of 2.0 molar hydrochloric acid, and the mixture was brought to 55-60° C., forming ferrous chloride. Next, two moles of sodium glycinate (194.1 g) and one mole of hydrochloric acid (36.5 g) were dissolved in the reaction mixture. After a 4 hour reaction time, the composition was cooled 40° C. and spray dried to obtain about 167.5 g of ferrous bisglycinate HCl at 100% yield.

What is claimed is:

1. An iron (II) amino acid chelate having a reducing agent bonded thereto, said reducing agent substantially maintaining the iron (II) in its ferrous oxidation state, said iron (II) amino acid chelate having an amino acid ligand to iron (II) molar ratio from 1:1 to 2:1, and a reducing agent ligand to iron (II) molar ratio from 1:1 to 4:1, with a proviso that the combination of the amino acid ligands and the reducing agent ligands satisfies from 3 to 6 of the coordination sites of the iron (II).

2. An iron (II) amino acid chelate as in claim 1, wherein the amino acid ligand to iron (II) molar ratio is 1:1.

3. An iron (II) amino acid chelate as in claim 1, wherein the reducing agent ligand to iron (II) molar ratio is from 1:1 to 2:1.

4. An iron (II) amino acid chelate as in claim 1, wherein the amino acid ligand to iron (II) molar ratio is 2:1 and the reducing agent ligand to iron (II) molar ratio is from 1:1 to 2:1.

5. An iron (II) amino acid chelate as in claim 4, wherein the reducing agent ligand to iron (II) molar ratio is 1:1.

6. An iron (II) amino acid chelate as in claim 4, wherein the reducing agent ligand to iron (II) molar ratio is 2:1.

7. An iron (II) amino acid chelate as in claim 1, wherein the reducing agent is bonded to the iron (II) as a bidentate ligand.

8. An iron (II) amino acid chelate as in claim 7, wherein the bidentate ligand is selected from the group consisting of ascorbic acid, citric acid, propionic acid, butyric acid, lactic acid, malic acid, succinic acid, sulfonic acid, and acetic acid.

9. An iron (II) amino acid chelate as in claim 1, wherein the reducing agent is bonded to the iron (II) as a unidentate ligand.

10. An iron (II) amino acid chelate as in claim 9, wherein the unidentate ligand is selected from the group consisting of ascorbic acid, citric acid, propionic acid, butyric acid, lactic acid, malic acid, succinic acid, hydrochloric acid, and acetic acid.

11. An iron (II) amino acid chelate as in claim 1, wherein the iron (II) amino acid chelate includes at least one amino acid selected from the group consisting of alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine, valine, and proteinates and combinations thereof.

12. An iron (II) amino acid chelate as in claim 1, wherein the iron (II) amino acid chelate includes two different amino acids individually chelated to the iron (II), said amino acids selected from the group consisting of alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine, valine, and combinations thereof.

13. A composition for delivering iron (II) to a subject, comprising:
an iron (II) amino acid chelate having a reducing agent bonded thereto, said reducing agent substantially maintaining the iron (II) in its ferrous oxidation state, said iron (II) amino acid chelate having an amino acid ligand to iron (II) molar ratio from 1:1 to 2:1, and a reducing agent ligand to iron (II) molar ratio from 1:1 to 4:1, with a proviso that the combination of the amino acid ligands and the reducing agent ligands satisfies from 3 to 6 of the coordination sites of the iron (II), and
a carrier.

14. A composition as in claim 13, wherein the amino acid ligand to iron (II) molar ratio is 1:1.

15. A composition as in claim 13, wherein the reducing agent ligand to iron (II) molar ratio is from 1:1 to 2:1.

16. A composition as in claim 13, wherein the amino acid ligand to iron (II) molar ratio is 2:1 and the reducing agent ligand to iron (II) molar ratio is from 1:1 to 2:1.

17. A composition as in claim 16, wherein the reducing agent ligand to iron (II) molar ratio is 1:1.

18. A composition as in claim 16, wherein the reducing agent ligand to iron (II) molar ratio is 2:1.

19. A composition as in claim 13, wherein the reducing agent is bonded to the iron (II) as a bidentate ligand.

20. A composition as in claim 19, wherein the bidentate ligand is selected from the group consisting of ascorbic acid, citric acid, propionic acid, butyric acid, lactic acid, malic acid, succinic acid, sulfonic acid, and acetic acid.

21. A composition as in claim 13, wherein the reducing agent is bonded to the iron (II) as a unidentate ligand.

22. A composition as in claim 21, wherein the unidentate ligand is selected from the group consisting of ascorbic acid, citric acid, propionic acid, butyric acid, lactic acid, malic acid, succinic acid, hydrochloric acid, and acetic acid.

23. A composition as in claim 13, wherein the iron (II) amino acid chelate includes at least one amino acid selected from the group consisting of alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine, valine, and proteinates and combinations thereof.

24. A composition as in claim 13, wherein the iron (II) amino acid chelate includes two different amino acids individually chelated to the iron (II), said amino acids selected from the group consisting of alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine, valine, and combinations thereof.

25. A composition as in claim 13, wherein the composition is in a solution or suspension liquid dosage form.

26. A composition as in claim 13, wherein the composition is in a solid dosage form.

27. A composition as in claim 13, wherein the solid dosage form is incorporated into a tablet or capsule.

28. A method of delivering iron (II) in its unoxidized form to the intestinal tract of a subject, comprising administering an iron (II) amino acid chelate having a reducing agent bonded thereto, said reducing agent substantially maintaining the iron (II) in its ferrous oxidation state, said iron (II) amino acid chelate having an amino acid ligand to iron (II) molar ratio from 1:1 to 2:1, and a reducing agent ligand to iron (II) molar ratio from 1:1 to 4:1, with a proviso that the combination of the amino acid ligands and the reducing agent ligands satisfies from 3 to 6 of the coordination sites of the iron (II).

29. A method as in claim 28, wherein the amino acid ligand to iron (II) molar ratio is 1:1.

30. A method as in claim 28, wherein the reducing agent ligand to iron (II) molar ratio is from 1:1 to 2:1.

31. A method as in claim 28, wherein the amino acid ligand to iron (II) molar ratio is 2:1 and the reducing agent ligand to iron (II) molar ratio is from 1:1 to 2:1.

32. A method as in claim 31, wherein the reducing agent ligand to iron (II) molar ratio is 1:1.

33. A method as in claim 31, wherein the reducing agent ligand to iron (II) molar ratio is 2:1.

34. A method as in claim 28, wherein the reducing agent is bonded to the iron (II) as a bidentate ligand.

35. A method as in claim 34, wherein the bidentate ligand is selected from the group consisting of ascorbic acid, citric acid, propionic acid, butyric acid, lactic acid, malic acid, succinic acid, sulfonic acid, and acetic acid.

36. A method as in claim 28, wherein the reducing agent is bonded to the iron (II) as a unidentate ligand.

37. A method as in claim 36, wherein the unidentate ligand is selected from the group consisting of ascorbic acid, citric acid, propionic acid, butyric acid, lactic acid, malic acid, succinic acid, hydrochloric acid, and acetic acid.

38. A method as in claim 28, wherein the iron (II) amino acid chelate includes at least one amino acid selected from the group consisting of alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine, valine, and proteinates and combinations thereof.

39. A method as in claim 28, wherein the iron (II) amino acid chelate includes two different amino acids individually chelated to the iron (II), said amino acids selected from the group consisting of alanine, arginine, asparagine, aspartic acid, cysteine, cystine, glutamine, glutamic acid, glycine, histidine, hydroxyproline, isoleucine, leucine, lysine, methionine, ornithine, phenylalanine, proline, serine, threonine, tryptophan, tyrosine, valine, and combinations thereof.

40. A method as in claim 28, where in the administration is by oral administration.

41. A method as in claim 28, where in the administration is by parenteral, mucosal, or transdermal administration.

42. A method as in claim 28, further including the steps of:
chelating the amino acids to the iron (II), and
bonding the reducing agent to said iron (II).

43. A method as in claim 42, wherein the steps of the chelating the amino acids to the iron (II) and the bonding of the reducing agent to the iron (II) occurs at substantially the same time.

44. A method as in claim 42, wherein the step of the chelating the amino acids to the iron (II) occurs before the bonding of the reducing agent to the iron (II).

45. A method as in claim 42, wherein the step of the chelating the amino acids to the iron (II) occurs after the bonding of the reducing agent to the iron (II).

45. A method as in claim 41, wherein the chelating the amino acids to the iron (II) and the bonding of the reducing agent to the iron (II) occurs in a common reaction mixture.
